(19) United States
(12) Patent Application Publication
(10) Pub. No.: US 2003/0024105 A1
(43) Pub. Date: Feb. 6, 2003

(54) Process for manufacturing fuse devices

(75) Inventor: Tony Chiu, Taipei (TW)

Correspondence Address: LADAS & PARRY, 5670 Wilshire Boulevard, Los Angeles, CA, 90036-5679, US

(73) Assignee: CONQUER ELECTRONICS CO., LTD.

(21) Appl. No.: 09/963,868

(22) Filed: Sep. 25, 2001

(30) Foreign Application Priority Data
Aug. 2, 2001 (TW) 090118868

(51) Int. Cl. H01H 69/02; H01R 43/00; H01H 9/02; H01H 9/06

(52) U.S. Cl. 29/623; 29/827; 29/857; 200/293

(57) ABSTRACT

A process for manufacturing fuse devices includes the steps of preparing an elongated metal sheet; forming a plurality of openings in the metal sheet so as to form a plurality of frame units, each of which includes a frame and a pair of opposing ribs that extend from the frame and that have spaced apart free ends; electrically connecting the free ends of the ribs of each of the frame units using a conductive wire; forming a dielectric body in each of the frame units; and cutting the ribs of the frame units at positions that are exposed from the respective one of the dielectric bodies so as to form a plurality of semi-finished fuse products.

### BACKGROUND OF THE INVENTION

1. Field of the Invention

The invention relates to a process for manufacturing fuse devices, more particularly to an automated process for the continuous production of fuse devices.

2. Description of the Related Art

Referring to FIG. 1, a conventional fuse device 100 is shown to include a dielectric body 10, a first metal cover 11, a second metal cover 13, and a metal wire 15. The dielectric body 10 is formed as a hollow rectangular block, and has two opposite open ends 101. Each of the first and second metal covers 11, 13 covers a respective one of the open ends 101. One end of the metal wire 15 is welded to the inner surface of the first metal cover 11, whereas the other end of the metal wire 15 abuts against the inner surface of the second metal cover 13.

The aforesaid fuse device 100 is produced by a process including the steps of: (a) forming the dielectric body 10 and the first and second metal covers 11, 13; (b) welding one end of the metal wire 15 to the inner surface of the first metal cover 11, and passing the other end of the metal wire 15 through the dielectric body 10 via the open ends 101, the metal wire 15 being crooked and having a length longer than that of the dielectric body 10; (c) mounting the first metal cover 11 on one of the open ends 101 of the dielectric body 10 after passing the metal wire 15 through the dielectric body 10; (d) providing a metal protrusion 131 on the inner surface of the second metal cover 13; and (e) mounting the second metal cover 13 on the other one of the open ends 101 of the dielectric body 10 such that the metal wire 15 abuts against the metal protrusion 131.

It is difficult to manufacture the conventional fuse device 100 of FIG. 1 continuously and automatically using the aforesaid process. Furthermore, the first and second metal covers 11, 13 should have sufficient space for welding the metal wire 15 thereon and for providing the metal protrusion 131 thereon. As such, it is difficult to reduce the size of the conventional fuse device 100. Additionally, since the metal wire 15 merely abuts against the metal protrusion 131, the stability of the conventional fuse device 100 is not inadequate.

Referring FIGS. 2 and 3, another conventional fuse device 200 is shown to include a dielectric body 20, a first metal cover 21, a second metal cover 22, and a circuit board 25. The circuit board 25 has two opposite connecting portions 251 and a metal wire 253. Two ends of the metal wire 253 are connected to the two connecting portions 251, respectively.

The aforesaid fuse device 200 is produced by a process including the steps of: (a) forming the dielectric body 20, the first metal cover 21, and the second metal cover 22; (b) mounting the circuit board 25 inside the dielectric body 20, wherein the circuit board 25 is produced by printing a plurality of circuit on a substrate, followed by cutting the substrate into individual circuit boards 25; and (c) mounting the first and second covers 21, 22 on the opposite open ends of the dielectric body 20.

The conventional fuse device 200 shown in FIG. 2 suffers problems similar to those of the fuse device 100 of FIG. 1, i.e. difficulty in producing the fuse device 200 continuously and automatically, difficulty in reducing the size of the fuse device 200, low production yield, etc.

### SUMMARY OF THE INVENTION

Therefore, the object of the present invention is to provide an automated process for the continuous production of fuse devices so as to overcome the aforesaid drawbacks of the prior art.

Another object of this invention is to provide a process for manufacturing miniature fuse devices.

Yet another object of this invention is to provide a process for manufacturing fuse devices with high productivity.

A further object of this invention is to provide fuse devices manufactured by the process of this invention.

Accordingly, the process for manufacturing fuse devices of this invention comprises the steps of: preparing an elongated metal sheet; forming a plurality of openings in the metal sheet so as to form a plurality of frame units that are connected in series along the length of the metal sheet, each of the frame units including a frame that confines a respective one of the openings, and a pair of opposing ribs that extend from the frame and that have spaced apart free ends extending oppositely into the respective one of the openings; electrically connecting the free ends of the ribs of each of the frame units using a conductive wire; forming a dielectric body in each of the frame units within a respective one of the openings in a manner that the free ends of the ribs extend into the dielectric body; and cutting the ribs of the frame units at positions that are exposed from the respective one of the dielectric bodies so as to form a plurality of semi-finished fuse products.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional fuse device;

FIG. 2 is a sectional view of another conventional fuse device;

FIG. 3 is a schematic view to illustrate the circuit board used in the conventional fuse device of FIG. 2 is produced;

FIG. 4 is a perspective view of a metal sheet according to the preferred embodiment of the process of this invention;

FIG. 5 is an exploded perspective view of a semi-finished fuse product according to the preferred embodiment of the process of this invention;

FIG. 6 is a sectional view of the preferred embodiment of the fuse device according to this invention; and

FIG. 7 is a flow diagram of the preferred embodiment of a process for manufacturing fuse device according to this invention.

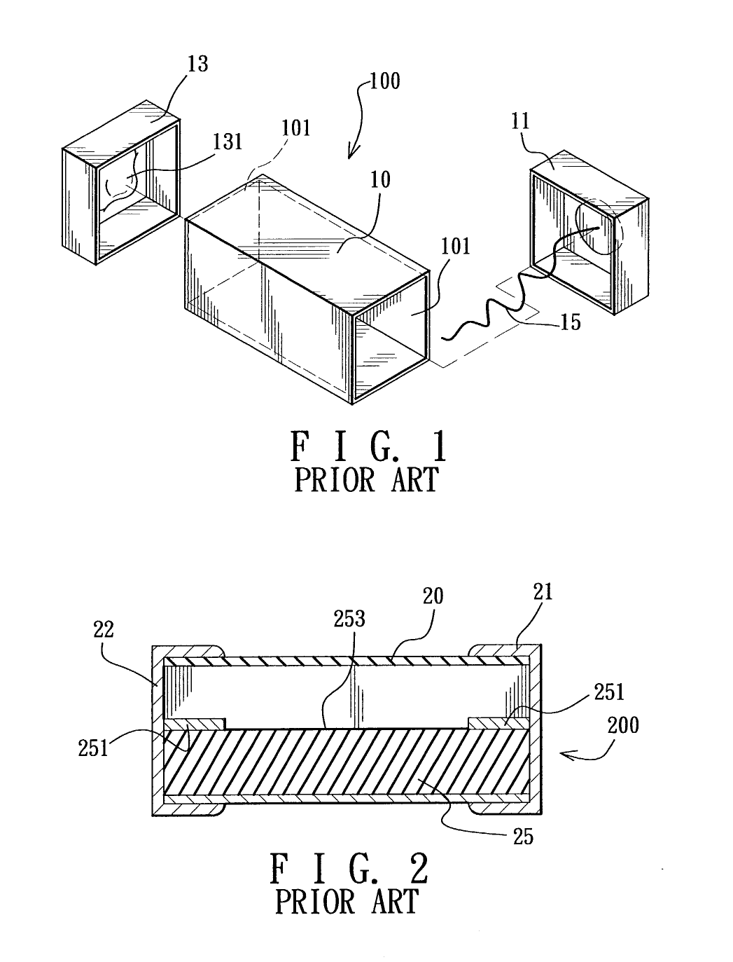

### DETAILED DESCRIPTION OF THE PREFERRED EMBODIMENTS

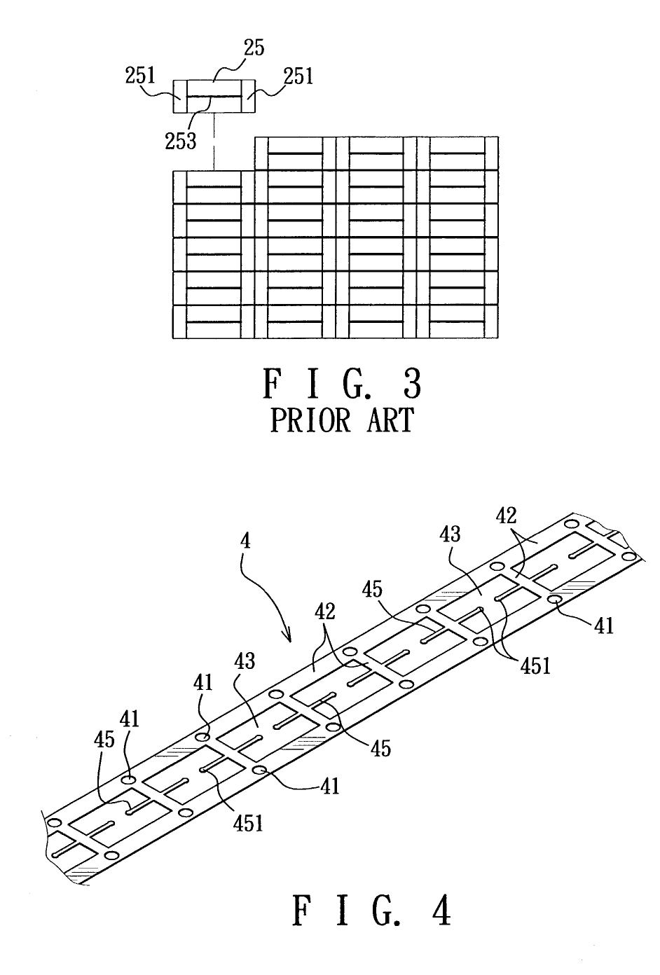

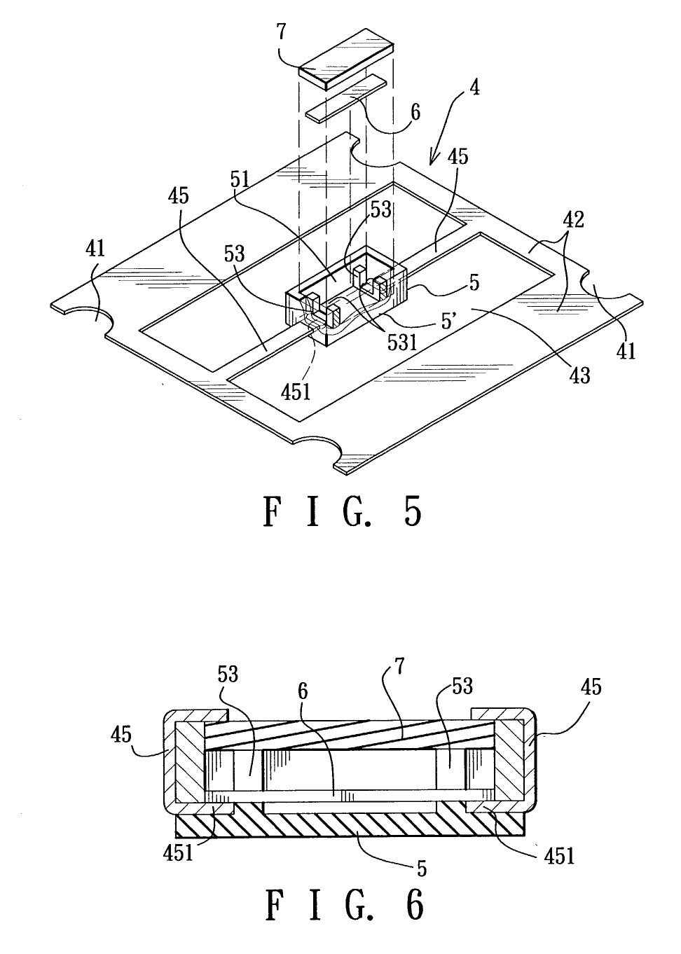

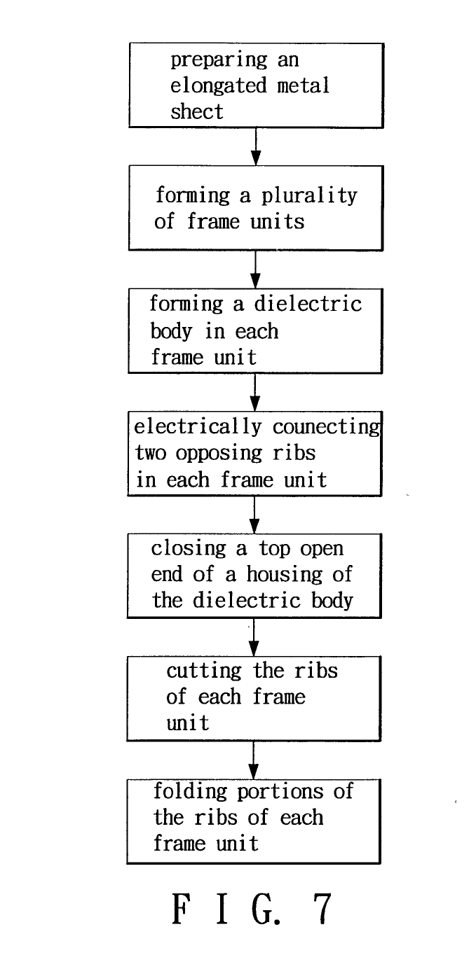

Referring to FIGS. 4, 5, 6 and 7, the preferred embodiment of the process for manufacturing fuse devices according to this invention comprises the steps of:

(1) Preparing an elongated metal sheet 4:

An elongated metal sheet 4 is prepared for disposing on an automated machine (not shown). The elongated metal sheet 4 is formed a plurality of retaining holes 41 along a respective one of two opposite longitudinal sides thereof. The retaining holes 41 are anchored on corresponding positions of a conveying device (not shown) of the automated machine for advancing the elongated metal sheet 4. The technique of anchoring the elongated metal sheet 4 on the corresponding positions of the conveying device is well known to one skilled in the art and thus, will not be described herein for the sake of brevity.

(2) Forming a plurality of frame units 43 along the length of the elongated metal sheet 4:

The elongated metal sheet 4 anchored on the conveying device is transported to a forming device, such as a puncher (not shown), to form a plurality of openings 43 in the elongated metal sheet 4, thereby forming a plurality of frame units 42 that are connected in series along the length of the elongated metal sheet 4. Each of the frame units 42 includes a frame that confines a respective one of the openings 43, and a pair of opposing ribs 45 that extend from the frame and that have spaced apart free ends 451 extending oppositely into the respective one of the openings 43.

(3) Forming a dielectric body 5 in each of the frame units 42:

The elongated metal sheet 4 after step (2) is transported to an apparatus for forming a dielectric body (not shown). The dielectric body 5 is formed in each of the frame units 42 within a respective one of the openings 43 in a manner that the free ends 451 of the ribs 45 extend into the dielectric body 5. The dielectric body 5 includes a housing 5′ that has a bottom wall and a peripheral wall projecting upwardly from the bottom wall to confine a receiving space therebetween and to define a top open end 51 of the housing 5′. The dielectric body 5 further includes a cover 7 for closing the top open end 51. Preferably, the housing 5′ is formed by injection molding at the free ends 451 of the ribs 45 with a resin. Moreover, the free end 451 of each rib 45 is wider than the remaining part of the rib 45 and is anchored in the housing 5′ so as to enhance the fastening of the free end 451 inside the housing 5′ of the dielectric body 5.

(4) Electrically connecting the free ends 451 of the ribs 45 of each of the frame units 42 using a conductive wire 6:

The elongated metal sheet 4 with the dielectric body 5 after step (3) is transported to a connecting apparatus (not shown). The conductive wire 6 is inserted into the housing 5′ via the top open end 51, and is electrically connected to the free ends 451 of the ribs 45 of the respective frame unit 42 by any appropriate technique. In this embodiment, the conductive wire 6 is electrically connected to the free ends 451 of the ribs 45 of the respective frame unit 42 by welding. However, other appropriate techniques well known to ones skilled in the art could also be used.

Alternatively, the sequence of the aforesaid steps (3) and (4) can be interchanged to achieve the same result.

Preferably, a pair of opposing U-shaped positioners 53 are formed in the housing 5′. The positioners 53 define a pair of positioning recesses 531 for receiving two opposite ends of the conductive wire 6.

The top open end 51 is then closed by the cover 7.

(5) Cutting the ribs 45 of the frame units 42 at positions that are exposed from the respective one of the dielectric bodies 5:

The elongated metal sheet 4 of step (4) is transported to a cutting apparatus (not shown) after the top open end 51 is closed by the cover 7. The ribs 45 of the frame units 42 are then cut at positions that are exposed from the respective one of the dielectric bodies 5 so as to form a plurality of semi-finished fuse products.

(6) Folding portions of the ribs 45 of each of the semi-finished fuse products:

The portions of the ribs 45 of each of the semi-finished fuse products, which are exposed from the respective one of the dielectric bodies 5, are folded in a manner that the portions of the ribs 45 partially wrap around two opposing sides of the respective one of the dielectric bodies 5. In this embodiment, the portions of the ribs 45 are wrapped toward the cover 7 so as to prevent the cover 7 from separating from the dielectric body 5.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A process for manufacturing fuse devices, comprising the steps of:
preparing an elongated metal sheet;
forming a plurality of openings in said metal sheet so as to form a plurality of frame units that are connected in series along the length of said metal sheet, each of said frame units including a frame that confines a respective one of said openings, and a pair of opposing ribs that extend from said frame and that have spaced apart free ends extending oppositely into the respective one of said openings;
electrically connecting said free ends of said ribs of each of said frame units using a conductive wire;
forming a dielectric body in each of said frame units within a respective one of said openings in a manner that said free ends of said ribs extend into said dielectric body; and
cutting said ribs of said frame units at positions that are exposed from the respective one of said dielectric bodies so as to form a plurality of semi-finished fuse products.

2. The process as claimed in claim 1, further comprising the step of folding portions of said ribs of each of said semi-finished fuse products, which are exposed from the respective one of said dielectric bodies, in a manner that said portions of said ribs partially wrap around two opposing sides of the respective one of said dielectric bodies.

3. The process as claimed in claim 1, wherein said dielectric body includes a housing that has a bottom wall and a peripheral wall projecting upwardly from said bottom wall to confine a receiving space therebetween and to define a top open end of said housing, said dielectric body further including a cover for closing said top open end.

4. The process as claimed in claim 3, further comprising the step of forming a pair of opposing U-shaped positioners in said housing, said positioners defining a pair of positioning recesses for receiving two opposite ends of said conductive wire.

5. The process as claimed in claim 3, wherein said housing is formed by injection molding at said free ends of said ribs with a resin.

6. A fuse device manufactured by the process of claim 2.
